(19) United States
(12) Patent Application Publication
(10) Pub. No.: US 2013/0346305 A1
(43) Pub. Date: Dec. 26, 2013

(54) MOBILE WALLET PAYMENT PROCESSING

(71) Applicant: Rui Mendes, Oakville (CA)

(72) Inventor: Rui Mendes, Oakville (CA)

(73) Assignee: CARTA WORLDWIDE INC., Oakville (CA)

(21) Appl. No.: 13/533,057

(22) Filed: Jun. 26, 2012

(51) Int. Cl. G06Q 20/36

(52) U.S. Cl. 705/41

(57) ABSTRACT

A method and system for mobile wallet payment processing. A request may be received from a mobile wallet operative on a mobile device for a virtual credit card, the request including device identification and a predefined payment form. A virtual credit card is dynamically issued by a payment processor responsive to the request. The virtual card is communicated to the mobile wallet on the mobile device and used to authorize a transaction with a vendor. A payment request is received from the vendor by the payment processor, which includes the virtual credit card, transaction details, and the identification of the mobile device authorizing the transaction. Upon verification of the information in the payment request and available funds, the payment processor processes payment for the transaction using the virtual credit card, with the predefined payment form used to satisfy any charges incurred by the virtual credit card.

### BACKGROUND

The following relates to mobile payments, mobile device communications, and so forth.

Mobile payment generally refers to regulated financial services that are performed by or from a mobile device. Mobile payment is an alternative method of payment that, instead of using cash, checks, or credit cards, the user may use a mobile phone to pay for a wide range of goods and services. There are currently four models for conducting such mobile payments, SMS-based transactional payments, direct mobile billing, mobile web payments (using Wireless Application Protocol (WAP) technology), and contactless near field communications.

SMS-based transactional payments require a user of the mobile device to send an SMS text message or the like, to a short code and a resulting premium charge is added to the user's phone bill or online wallet (as described below). The merchant in the transaction is then informed of the success of the payment and may release the goods, perform the services, etc. Unfortunately, this type of mobile payment has poor reliability, is slow, provides minimal security, high start-up and operating costs, and the like.

Direct mobile billing generally involves a two-factor authentication (e.g., PIN and one-time-password) following which the user's mobile device account is charged for the purchase. Such payment is typical of payments made using mobile phones via ITUNES and ANDROID MARKET, e.g., payment for purchase of games, apps, music, etc. The security for such billing is higher than the SMS-based transactions, faster, convenient (no pre-registration, input of credit/debit cards), and easy (for online purchases). However, this method is limited to online purchases from the aforementioned sites or sites operated by the user's carrier. Additionally, already large carrier telephone bills may present a substantial shock to the user when such purchases are added.

Mobile web payments provide for the display and usage of web sites or downloaded applications to make payments to vendors. This type of operation inherently includes the benefits and disadvantages associated with web-based payments. For example, the user must still pre-register some form of credit card (unless directly billed to the carrier as set forth above); the process mirrors the typical online purchase format familiar to Internet users; if no pre-registration is available, the user must enter credit card information directly via the mobile device, which is prone to entry errors, and the like. Online wallets provided by PAYPAL, AMAZON PAYMENTS and GOOGLE CHECKOUT have mobile options, which involves online user registration. The user first provides a telephone number to one of the online wallet operators, whom then returns an SMS message having a PIN. The user then authenticates the number by entering the PIN and inputs credit card information or another payment method. Payments are then validated during a limited number of transactions. That is, the online wallets are useful for online purchases from a fixed location from online vendors. However, mobility is an issue as the online wallet is maintained by the providers and not on the mobile device, which is especially disadvantageous at a retail establishment that does not provide for online purchases.

Near Field Communication (NFC) is generally used in physical transactions, wherein the vendor and the user are in close physical proximity, e.g., at retail establishments, transportation services, restaurants, and the like. This type of mobile payment requires a specially designed mobile device equipped with a smartcard that is “swiped” by holding the mobile device in close physical proximity to a card reader. The transaction in question may involve direct billing, PIN-based authentication, bank billing, pre-paid account, or the like. Unfortunately, this method requires a suitably equipped mobile device, as well as suitably equipped card readers at the point-of-sale. Widespread adoption of NFC has thus been hindered by users unwilling to purchase new phones equipped with NFC, vendors unwilling to purchase the equipment necessary to read NFC devices, mobile device manufacturers unwilling to incorporate additional features over which they have little control, etc.

A mobile wallet, in contrast to an online wallet, may include software, hardware, or a combination thereof, resident on a mobile device, that includes one or more linked accounts. However, current implementations of mobile wallets are based on specific infrastructure and/or network acceptance. For example, STARBUCKS mobile wallet is only accepted at their corresponding coffee establishments, PAYPAL is only accepted when online merchants connect to PAYPAL, GOOGLE CHECKOUT (mobile wallet variant) only works if you use a CITIBANK credit card, in a specific region, and using a specific device.

Thus, it would be advantageous to provide a generic mobile wallet method and system that is ubiquitous and operable independent of specific infrastructure, device, or network acceptance.

### BRIEF DESCRIPTION

In accordance with one aspect of the exemplary embodiment, a method for mobile wallet payment processing includes receiving a request for a virtual credit card from a mobile wallet operative on an associated mobile device, the request including a device identification and a predefined payment form. The method also includes dynamically issuing, with a processor, a virtual credit card responsive to the request, the virtual credit card associated with the device identification and the predefined payment form, and communicating the dynamically issued virtual credit card to the mobile wallet operative on the associated mobile device. The method further includes receiving a payment request from a vendor for payment for at least one of a good or a service, the payment corresponding to a charge to the virtual credit card, and verifying funds associated with the virtual credit card relative to the charge of the payment request. In addition, the method includes rendering the payment to the vendor using the virtual credit card responsive to a verification of the funds associated with the virtual credit card.

In another aspect, a mobile wallet payment processing system includes a virtual credit card issuer that is configured to dynamically issue a virtual credit card in response to a request received from a mobile wallet on an associated mobile device, the request including a device identification and a predefined payment form, and communicating the dynamically issued virtual credit card to the mobile wallet. The system also includes a payment processing component that is configured to analyze a payment request for payment of a transaction for at least one of a good or a service, the payment corresponding to a charge to the virtual credit card. The payment processing component is also configured to verify funds associated with the virtual credit card relative to the charge of the payment request, and to render the payment to the vendor using the virtual credit card responsive to a verification of the funds associated with the virtual credit card. In addition, the system includes a processor which implements at least one of the virtual credit card issuer and the payment processing component.

In another aspect, a computer-implemented method for mobile wallet payment processing that includes selecting at least one predefined payment form corresponding to at least one of a checking account, a savings account, a credit card account, a debit card account, or a charge account. The method also includes linking, with a processor, the at least one selected predefined payment source to a mobile wallet on an associated mobile device, and receiving a dynamically issued virtual credit card from an associated payment processor, the virtual credit card funded from the at least one selected predefined payment source linked to the mobile wallet. Additionally, the method includes receiving an authorization request from a vendor for payment for at least one of a good or a service, the payment corresponding to a charge to the virtual credit card, and rendering the payment to the vendor using the virtual credit card responsive to an approval of the authorization request.

### BRIEF DESCRIPTION OF THE DRAWINGS

FIG. 1 is a functional block diagram of a system for mobile wallet payment processing in accordance with one aspect of the exemplary embodiment.

FIG. 2 is a flow chart which diagrammatically shows a method for mobile wallet payment processing in accordance with one aspect of the exemplary embodiment.

FIG. 3 is a flow chart which diagrammatically shows a portion of a method for mobile wallet payment processing in accordance with one aspect of the exemplary embodiment.

FIG. 4 is a flow chart which diagrammatically shows another portion of the method for mobile wallet payment processing in accordance with one aspect of the exemplary embodiment.

### DETAILED DESCRIPTION

One or more implementations of the subject application will now be described with reference to the attached drawings, wherein like reference numerals are used to refer to like elements throughout.

As described herein, there is provided a method for mobile wallet payment processing. It will be appreciated that the subject systems and methods described hereinafter provide mobile wallet payment processing operations that offer increased acceptance across any infrastructure or network acceptance, in contrast to other existing mobile payment schemes, as referenced above. With respect to the example implementation regarding a mobile wallet on a mobile device, mobile payment improvement may correspond to an increased usage by consumers, and acceptance by vendors, as well as a decrease in costs associated with mobile payments, or other like parameters. Additional improvements may be an increase in the simplicity of mobile payments, such as a reduction in the amount of time needed to consummate a transaction using a mobile device.

Accordingly, the embodiments set forth in greater detail below include mobile wallet payment processing operations that may be implemented independent of specific infrastructure or network acceptance.

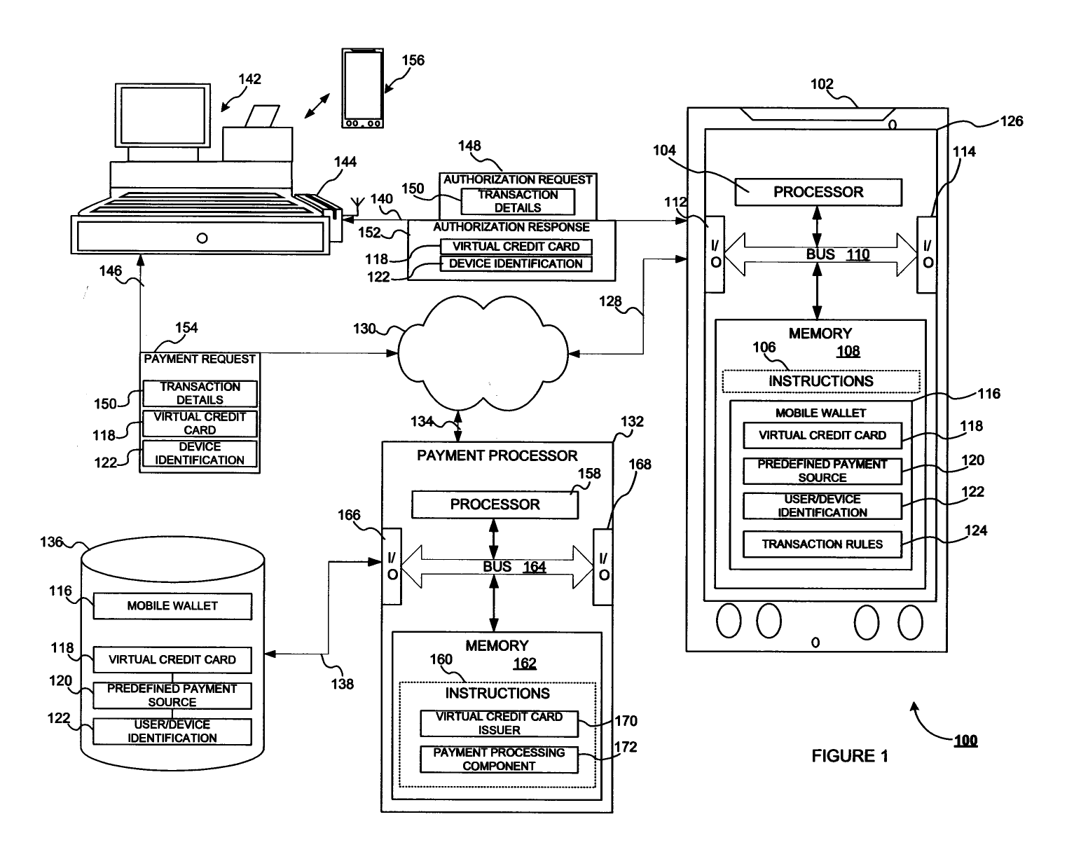

Referring now to FIG. 1, there is shown a functional block diagram of a computer-implemented system 100 for mobile wallet payment processing. It will be appreciated that the various components depicted in FIG. 1 are for purposes of illustrating aspects of the subject application, and that other similar components, implemented via hardware, software, or a combination thereof, are capable of being substituted therein.

The mobile wallet payment system 100 is capable of implementation using a distributed computing environment, such as a computer network, which is representative of any distributed communications system capable of enabling the exchange of data between two or more electronic devices. Such a computer network may include, for example, a virtual local area network, a wide area network, a personal area network, a local area network, the Internet, an intranet, a cellular network, or any suitable combination thereof. The computer network may include physical layers and transport layers, e.g., Token-Ring, Ethernet, LTE, Wi-Max, or other wireless or wire-based data communication mechanisms. Furthermore, while depicted in FIG. 1 as a networked set of components, the system and method are capable of implementation on a stand-alone device adapted to perform the methods described herein.

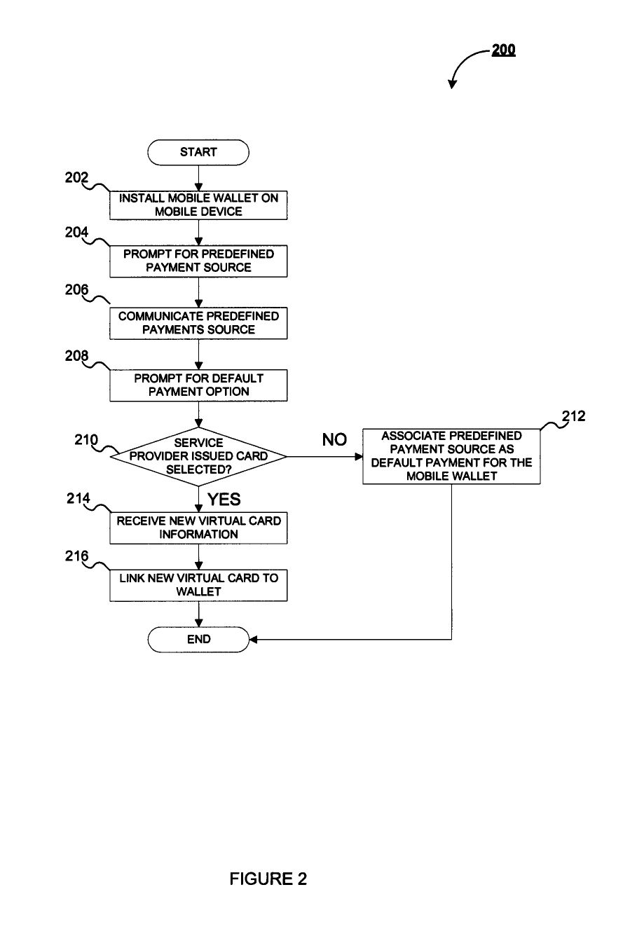

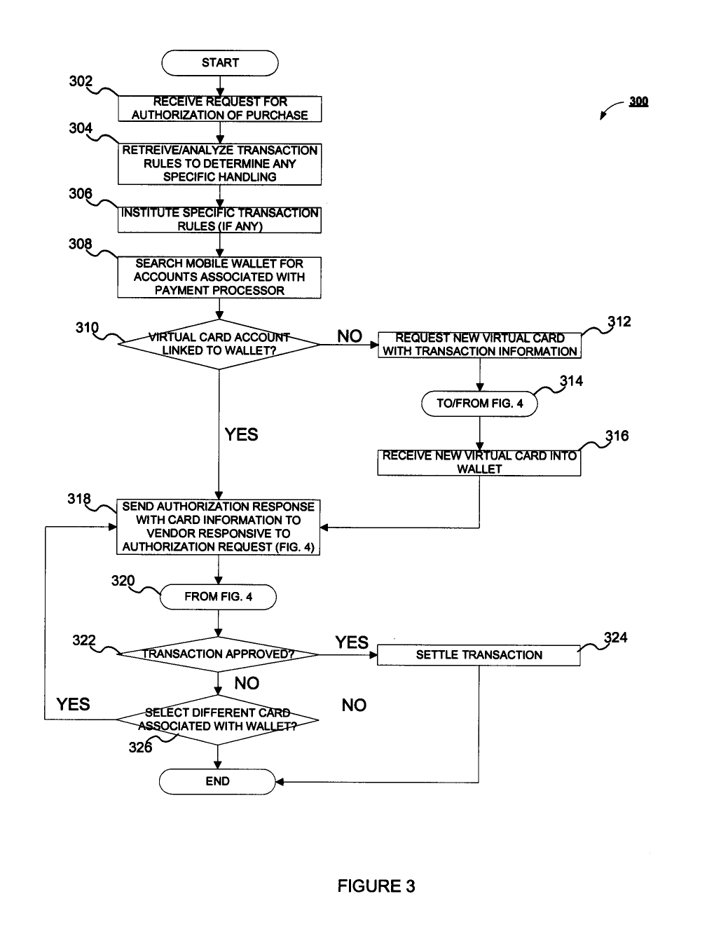

As shown in FIG. 1, the mobile wallet payment system 100 includes a mobile device 102 having a processor 104, which is capable of implementing at least a portion of the exemplary method described in FIGS. 2-3 by execution of software processing instructions 106 which are stored in memory, such as memory 108, which is communicatively coupled to the processor 104. The mobile device 102 may include a smart phone, cellular telephone, tablet, notebook computer, netbook computer, personal data assistant, a combination thereof, or any other suitable computing device. The mobile device 102 may further include hardware, software, and/or any suitable combination thereof, configured to interact with an associated user, a networked device, networked storage, removable storage, display, user interface components, remote devices, radio transceivers, or the like. The processor 104 may also control the overall operations of the mobile device 102.

The memory 108 may include, for example and without limitation, a mobile wallet 116 that is capable of storing information related to a virtual credit card 118, a predefined payment source 120, user/device identification information 122, transaction rules 124, and the like. In accordance with one embodiment, the mobile Wallet 116 may be downloaded or retrieved from the payment processor 132 and operable in the memory 108 of the mobile device 102, or may be installed as specific hardware in the mobile device 102. As illustrated in FIG. 1, the mobile wallet 116 may include a virtual credit card 118, which may be issued on the fly during a transaction, issued by the payment processor 132 during set up of the mobile wallet 116, upon request from a user associated with the mobile device 102, or the like. The virtual credit card 118 may correspond to a credit card, a charge card, or prepaid card issued by the payment processor 132 in association with MASTERCARD, VISA, DISCOVER CARD, AMERICAN EXPRESS, etc., rules and regulations. Accordingly, the mobile wallet 116 may further store one or more transaction rules or regulations 124 associated with the virtual credit card 118, operation of the mobile wallet 116, instructions for processing transactions with vendors 142, and the like. For example, the transaction rules 124 may include special handling instructions for certain vendors, products, services, locations, etc., which may indicate the type of payment to use, type of authorization, type of validation, type of user identification (e.g., PIN, social security number, mother's maiden name, etc.), and the like.

The mobile wallet 116 may also include some form of predefined payment source 120, i.e., a credit card account, checking account, savings account, a charge card account, debit card account, etc., associated with the user that is provided by a bank, a financing company, a governmental entity, the payment processor 132, or the like. According to one embodiment, the predefined payment source 120 may be used to fund or “top-up” the virtual credit card 118, as discussed in greater detail below. The mobile wallet 116 may also include some form of user/device identification information 122, which may be used to identify/authenticate the user associated with the mobile device 102. According to one embodiment, the user/device identification 122 may be communicated to the payment processor 132 during installation of the wallet 116 on the mobile device 102, a registration process associated with the user/mobile device 102, provided by the user during association of the predefined payment source 120, or the like. In addition, the user/device identification 122 may be required during the processing of a transaction with the vendor 142, as discussed in greater detail below.

The mobile device 102 may also include one or more communications interface devices 112, 114 for communicating with external devices or to receive external input. The I/O interface 114 may communicate with a user input/display device 126 for displaying information to users, and for receiving user input, such as a keyboard or touch/writable screen, for inputting text, and/or a cursor control device, and the like, for communicating user input information and command selections to the processor 104. The I/O interface 112 may receive a virtual credit card 118 from a payment processor 132, an authorization request 148 including transaction details 150 from a vendor 142, send an authorization response 152 including virtual card information 118 and device identification 122, and the like, as are discussed in greater detail below. The various components of the mobile device 102 may be all connected by a data/control bus 110.

The memory 108 may represent any type of non-transitory computer readable medium such as random access memory (RAM), read only memory (ROM), magnetic disk or tape, optical disk, flash memory, or holographic memory. In one embodiment, the memory 108 comprises a combination of random access memory and read only memory. In some embodiments, the processor 104 and memory 108 may be combined in a single chip. In another embodiment, the memory 108 may further correspond to any mass storage device(s), for example, magnetic storage drives, a hard disk drive, optical storage devices, flash memory devices, or a suitable combination thereof. The network interface(s) 112, 114 allow the mobile device 102 to communicate with other devices via a computer network, a cellular network, advanced cellular networks, personal area networks, and may comprise a modulator/demodulator (MODEM). Memory 108 may store data the processed in the method as well as the instructions 106 for performing the exemplary method.

The digital processor 104 can be variously embodied, such as by a single core processor, a dual core processor (or more generally by a multiple core processor), a digital processor and cooperating math coprocessor, a digital controller, or the like. The digital processor 104, in addition to controlling the operation of the mobile device 102, executes instructions stored in memory 108 for performing portions of the methods outlined in FIGS. 2-4.

The mobile wallet payment system 100 illustrated in FIG. 1 may further include a payment processor device 132 associated with a payment processor that is in data communication with the network 130 via a communications link 134. The payment processor device 132 may include a processor 158, which is capable of implementing at least a portion of the exemplary method described in FIGS. 2-4 by execution of software processing instructions 160 which are stored in memory, such as memory 162, which is communicatively coupled to the processor 158. The processor 158 may also control the overall operations of the payment processor 132.

It will be appreciated that the payment processor 132 is representative of a computing device that is capable of facilitating interaction among disparate other computing devices in data communication therewith, such as, for example and without limitation, the mobile device 102, the vendor device 142, and the like. In accordance with one embodiment, the payment processor 132 is capable of being employed as one possible hardware configuration to support the systems and methods described herein. Accordingly, although the payment processor 132 is illustrated as a standalone computing device, any suitable computing environment is may be employed. For example, computing architectures including, but not limited to, multiprocessor, distributed, tablet, mainframe, supercomputer, digital and analog can be employed in accordance with varying embodiments set forth herein. It will further be appreciated that the payment processor 132 may include computer workstations, personal computers, combinations thereof, or any other computing devices.

The memory 162 may include, for example and without limitation, instructions 160 which are executed by the processor 158 for performing at least a portion of the methods set forth in FIGS. 2-4. The instructions 160 may include a virtual credit card issuer 170, that is configured to issue credit cards, prepaid cards, and the like, in accordance with rules and regulations established by MASTERCARD, VISA, DISCOVER CARD, AMERICAN EXPRESS, or the like. The virtual credit card issuer 170 of the payment processor 132 may further be configured to generate, i.e., issue, credit cards, encrypt data associated with a user or account on credit cards or associated semiconductor chips, perform the card monetary authorizations and settle all funds with all parties involved, e.g., a vendor 142, the consumer (mobile device 102), a bank, etc. The payment processor 132 is illustrated in FIG. 1 as a server for example purposes only, and it will be appreciated that any suitable hardware, software, or combinations thereof, are capable of assisting in the issuance of virtual credit cards 118 as set forth in greater detail below.

In some instances, the virtual credit card issuer 170 of the payment processor 132 may issue virtual cards 118 on demand for a specific purchase, provide physical cards to a user (e.g., barcodes for attachment to the mobile device 102), wrist watches (integral electronics storing and communicating account information), or other like technologies associated with user mobility. The virtual credit card issuer 170 of the payment processor 132 may send and receive information to the mobile device 102 corresponding to the mobile wallet 116, for example communicating a virtual credit card 118 for use by the mobile wallet 116 for transactions. For example, the virtual credit card issuer 170 of the payment processor 132 may be configured to dynamically generate a virtual credit card 116 that may be used in completing a transaction between the vendor 142 and the mobile device 102.

The virtual credit card issuer 170 may also be configured to utilize the predefined payment source 120, i.e., a credit card account, checking account, savings account, a charge card account, debit card account, etc., associated with the user that is provided by a bank, a financing company, a governmental entity, or the like, to fund or “top-up” the virtual credit card 118, as discussed in greater detail below.

The instructions 160 may also include a payment processing component 172 that is configured to respond to a payment request 154 from the vendor 142, which includes transaction details 150, virtual card information 118, device identification 122, and the like. In such a configuration, the payment processing component 172 of the payment processor 132 may provide payment to the vendor 142 enabling the completion of the transaction.

The payment processor 132 may also include one or more communications interface devices 166, 168 for communicating with external devices or to receive external input. The I/O interface 166 may communicate with the data storage, device 136. The data storage device 136 may be any mass storage device known in the art including, for example and without limitation, magnetic storage drives, a hard disk drive, optical storage devices, flash memory devices, or any suitable combination thereof. In accordance with one embodiment, the data storage device 136, illustrated in FIG. 1 as a database, may be configured to store an online mobile wallet 116 corresponding to the mobile wallet 116 on the mobile device 102, one or more virtual credit cards 118 issued by the payment processor 132, one or more predefined payment sources 120 supplied by the user of the mobile device 102, user/device identification information 122, and the like. It will be appreciated that the virtual credit card 118, the payment source 120, and the identification information 122 may be stored in association with each other, such that each mobile device 102 or user has an associated mobile wallet 116, virtual credit cards 118, payment sources 120, identification information 122, and the like.

The I/O interface 168 may communicate with the network 130 via the communications link 134, send a virtual credit card 118 to the mobile device 102, receive a payment request 154 including transaction details 150 from a vendor 142, communicate with one or more banks (not shown), and the like, as are discussed in greater detail below. The various components of the payment processor 132 may be all connected by a data/control bus 164. In one embodiment, the payment processor 132 is capable of processing closed-loop accounts (accounts that are only accepted at a single retailer or subset of retailers) or open-loop (branded card, such as MASTERCARD, VISA, etc., acceptable wherever such brands are accepted). The payment processor 132 may provide end-to-end services, e.g., issuing, processing, and reconciliation operations.

According to one embodiment, the communications link 134 may include, for example and without limitation, 802.11a, 802.11b, 802.11g, 802.11(x), WiMax, LTE, Bluetooth, the public switched telephone network, GSM, CDMA, a proprietary communications network, infrared, optical, or any other suitable wired or wireless data transmission communications known in the art. Various network protocols, implementations or models may be used to facilitate communications amongst the various components illustrated in FIG. 1 including, for example and without limitation, TCP/IP, token rings, Ethernet, WAN, VLAN, WLAN, Internet, other packet-switching protocols, or the like. Additional operations of the payment processor 132 will be better understood in conjunction with the exemplary embodiments of FIGS. 2-4, as discussed below.

The memory 162 may represent any type of non-transitory computer readable medium such as random access memory (RAM), read only memory (ROM), magnetic disk or tape, optical disk, flash memory, or holographic memory. In one embodiment, the memory 162 comprises a combination of random access memory and read only memory. In some embodiments, the processor 158 and memory 162 may be combined in a single chip. In another embodiment, the memory 162 may further correspond to any mass storage device(s), for example, magnetic storage drives, a hard disk drive, optical storage devices, flash memory devices, or a suitable combination thereof. The network interface(s) 166, 168 allow the payment processor 132 to communicate with other devices via a computer network the computer network 130, a cellular network, advanced cellular networks, personal area networks, and may comprise a modulator/demodulator (MODEM). Memory 162 may store data the processed in the method as well as the instructions 160 for performing the exemplary method.

The digital processor 158 can be variously embodied, such as by a single core processor, a dual core processor (or more generally by a multiple core processor), a digital processor and cooperating math coprocessor, a digital controller, or the like. The digital processor 158, in addition to controlling the operation of the payment processor 132, executes instructions stored in memory 162 for performing portions of the method outlined in FIGS. 2-4.

The mobile wallet payment system 100 illustrated in FIG. 1 further includes at least one vendor device 142, depicted as a point-of-sale device such as, for example and without limitation, a cash register, a networked computing device, or the like. FIG. 1 further illustrates a mobile device 156, which is also capable of functioning as a vendor device 142 in accordance with the systems and methods described herein. Thus, as referenced hereinafter, the vendor device 142 may refer to the point-of-sale device or mobile device 156 shown in FIG. 1. According to one embodiment, the vendor device 142 includes a processor and memory (not shown) operable to facilitate interactions with the mobile device 102 and/or the payment processor 132, as discussed in greater detail below. In such an embodiment, the vendor device 142 includes a wired or wireless interface device 144, such as a card reader, NFC reader, smartcard reader, proprietary interface, network interface card, BLUETOOTH module, I/R module, or the like.

As shown in FIG. 1, the vendor device 142 is configured to communicate with the mobile device 102 via the communications link 140, and with the network 130 via the communications link 146. The communications links 140 and 146 may comprise, for example and without limitation WiMax, LTE, 802.11a, 802.11b, 802.11g, 802.11(x), Bluetooth, the public switched telephone network, a proprietary communications network, infrared, optical, or any other suitable wired or wireless data transmission communications known in the art. In accordance with one embodiment, the communications link 140 may be implemented as a short distance wireless communication transmission, such as, NFC, BLUETOOTH, I/R, or the like.

Although illustrated in FIG. 1 as a point-of-sale device, the vendor 142 may be implemented as a website, another mobile device (e.g., the vendor mobile device 156), or other suitable computing system capable of interaction with the mobile device 102 and the mobile wallet 116 stored thereon. It will be appreciated that the vendor 142 may include suitable hardware, software, or combinations thereof, configured to interact with the mobile device 102, the network 130, the payment processor 132, and the like. For example, the vendor 142 may include a processor, memory, a system bus, instructions, network interface cards, wireless transceivers, and the like, operable to facilitate transactions as set forth herein.

In accordance with one embodiment, the vendor 142 may be configured to communicate a request 148 for authorization of a purchase to the mobile device 102, which request 148 includes details 150 assoicated with the current transaction. The mobile device 102, in accordance with the mobile wallet 116 resident thereon, determines whether a virtual card 118 associated with the payment processor 132 is associated with the mobile wallet 116. When no such card 118 is present, a new virtual credit card 118 is requested and received from the payment processor 132. This virtual card 118 may then be stored in the mobile wallet 116 for use in the current and/or future transactions. The card may be issued in response to transaction information 150 communicated by the mobile device 102 to the payment processor 132, or just issued for this specific transaction by the payment processor 132 in response to a payment request 154 received from the vendor 142 (as discussed in greater detail below).

The mobile device 102 may then communicate an authorization response 152 approving the transaction to the vendor 142. The authorization received from the mobile device 102 may include payment information corresponding to the virtual card 118 dynamically issued by the payment processor 132, a previously created virtual card 118, or the like.

After receiving the authorization approval from the mobile device 102, the vendor communicates a payment request 154 including the virtual card information 118, device identification 122, and transaction details 150 to the payment processor 132 for approval to complete the transaction. The payment processor 132 may then verify the identity of the mobile device 102 based upon device identification 122 which is associated with the transaction information 150, i.e., verify that the mobile device 102 which communicated the virtual card information 118 is the mobile device 102 to which the payment processor 132 issued the virtual card. Funding of the virtual card 118 is then performed by the payment processor 132 using an account serviced by the payment processor 132 associated with the mobile device 102. In one embodiment, funding of the virtual card 118 may be made by the payment processor 132 in accordance with previously received instructions from the user associated with the mobile device 102, transaction rules, associated credit cards, or the like.

In such an embodiment, any predefined payment method 120 may be used as the manner in which the virtual card receives funds or from which credit in at least the amount needed to complete the transaction. The payment processor 132 analyzes the request 154 and identifies the mobile device 102 associated with the transaction. The payment processor 132 may then load funds onto the virtual card 118 and allow payment to be made to the vendor 142 as requested, using an account previously registered with the payment processor 132, e.g., a predefined payment form 120 such as a credit card, checking account, savings account, etc The transaction associated with the request 154 is then approved, which approval is communicated back to the vendor 142 to allow the user associated with the mobile device 102 to receive the goods or services associated with the transaction.

In accordance with another embodiment, the vendor 142 may be configured to communicate an authorization request 148, including details of the transaction 150, to the mobile device 102 so as to initiate completion of a sales transaction. For example, the user may select a good or service to purchase from the vendor 142 and proffer the mobile device 102 for mobile payment. The vendor device 142 may then communicate an authorization request 148 containing the transaction details 150 to the mobile wallet 116 for authorization. In the event that the wallet 116 already includes a virtual credit card 118, the mobile device 102 submits the virtual credit card 118 and authorizes the payment in response to the authorization request 148. When the mobile wallet 116 does not include a suitable virtual credit card 118, or the virtual credit card 118 on the mobile device 102 lacks sufficient funds, the mobile device 102 may contact the payment processor 132 via the network 130 for suitable funding. The payment processor 132 may generate a new virtual card 118 on the fly, top up an amount on the card 118 using the predefined payment source 120, or the like. That is, a valid credit card may be dynamically issued as needed by the payment processor 132 for use by the mobile device 102 in making a payment for a transaction. The new or updated virtual credit card 118 is then sent to the mobile device 102 for use by the mobile wallet 116.

The term “software,” as used herein, is intended to encompass any collection or set of instructions executable by a computer or other digital system so as to configure the computer or other digital system to perform the task that is the intent of the software. The term “software” as used herein is intended to encompass such instructions stored in storage medium such as RAM, a hard disk, optical disk, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

Turning now to FIG. 2, there is shown a flow chart 200 illustrating an exemplary method for configuring mobile wallet payment processing on an associated mobile device 102. FIG. 3, discussed below, depicts a flow chart 300 illustrating an exemplary implementation of mobile wallet payment processing. As will be appreciated, the steps of the method need not all progress in the order illustrated and fewer, more, or different steps may be performed. While reference is made herein to the mobile device 102, other computer systems are also capable of implementation and use in accordance with the method of FIGS. 2 and 3.

At 202, the mobile wallet 116 is installed on the mobile device 102. As discussed above, the mobile wallet 116 may comprise an application downloaded by the mobile device 102 for installation thereon, e.g., an “app” downloaded from ITUNES, ANDROID sites, BLACKBERRY sites, WINDOWS sites, from the payment processor 132, from an online store (e.g., associated with vendor 142), or the like. The mobile wallet 116 may also be installed on the mobile device 102 via integration of specific hardware, firmware updates, software updates, or the like. According to one embodiment, the mobile wallet 116 is provided to users holding certain physical credit cards, e.g., holders of VISA, MASTERCARD, DISCOVERY, or AMERICAN EXPRESS credit cards, or holders of prepaid credit or gift cards associated with such credit card providers. It will be appreciated that the installation of the mobile wallet 116 on the mobile device 102 may be initiated by an associated user, by a service provider, by an already installed application, by a technician, or the like.

At 204, the associated user is prompted, via a suitable graphical user interface on the display 126 of the mobile device 102, to register, e.g., input, one or more predefined payment sources 120 to be associated with the user/mobile device 102 with respect to the payment processor 132. That is, the user associated with the mobile device 102 is prompted to input one or more payment sources 120 (e.g., a bank account, savings account, credit card number, debit card number) that may be used by the virtual credit card issuer 170 of the payment processor 132 to issue a virtual credit card 118 for the mobile wallet 116, as discussed in greater detail below. According to one embodiment, the installation and provisioning of information by the user via the mobile device 102 may be accomplished between the payment processor 132 and the mobile device 102 online (via direct network connections, e.g., the network 130), offline (internal to the wallet 116 on the mobile device 102), or a combination of the two, dependent upon the network connectivity of the mobile device 102. As such, at 206, the predefined payment source 120 is communicated to the payment processor 132 in accordance with one of the examples just set forth.

At 208, the user is prompted to select a default payment option to be used by the mobile wallet 116 for completing transactions. For example, the user may designate one of a plurality of credit cards (predefined payment source 120) as the default payment to be used for transactions, may designate a checking or savings account, or the like. A determination is then made whether the default payment selected by the user corresponds to a card (account) that has been issued by the payment processor 132 at 210. That is, a determination is made whether the selected default payment of the mobile wallet 116 operating on the mobile device 102 (when offline) or through the payment processor 132 (when online) corresponds to a credit card account not processed by the payment processor 132 (e.g., a bank issued VISA, MASTERCARD, etc., credit card, a checking account, or the like).

When the selected default payment does not correspond to a card account issued by the payment processor 132, operations proceed to 212. At 212, one of the predefined payment sources 120 is designated as the default payment option to be used in subsequent transactions involving the mobile wallet 116. That is, when the user neglects to identify a particular card account for use as the default payment option, or when the selected card account is not one that was issued by the payment processor 132, one of the predefined payment sources 120 is designated to be used by the mobile wallet 116 when prompted for payment by a vendor 142. For example, the user may designate an AMERICAN EXPRESS credit card account as the default payment option. In such an example, the mobile wallet 116, when prompted for payment authorization, i.e., the authorization request 148, will use that AMERICAN EXPRESS credit card account (for topping up a virtual card 118 issued by the virtual credit card issuer 170 of the payment processor 132, as discussed more fully above).

According to such an example embodiment, the mobile wallet 116 may request a virtual card 118 from the payment processor 132 to be used in a particular transaction, with the virtual card 118 then issued by the virtual credit card issuer 170 on-the-fly and used to satisfy the transaction. The virtual credit card issuer 170 of the payment processor 132 may then charge or debit the predefined payment source 120 for the amount, such that the user only sees the charges/debits as associated with the predefined payment source 120, i.e., no knowledge that payment to a vendor 142 was actually accomplished using the virtual credit card 118. For example, the user selects an AMERICAN EXPRESS card to be used for mobile payments, while the payment processor 132 is authorized to issue prepaid MASTERCARD cards. When a transaction is initiated, the processor 132 dynamically generates a new MASTERCARD having the amount necessary to satisfy the vendor 142 to complete the transaction, while also charging the corresponding amount to the AMERICAN EXPRESS card. Thus, the user only sees the charges to the AMERICAN EXPRESS card and not the actual virtual credit card 118 that was used to complete the transaction with the vendor 142. Operations then terminate with respect to FIG. 2.

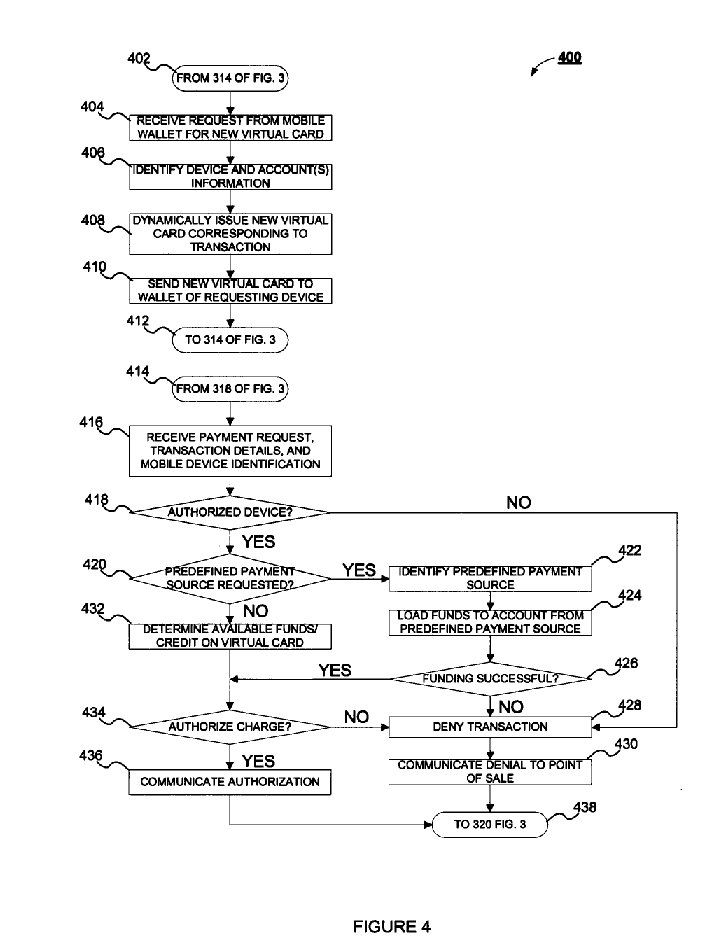

Returning to 210, when it is determined that the default payment option selected by the user corresponds to a card account that is issued by or serviced by the payment processor 132, operations proceed to 214. At 214, the mobile device 102 receives a virtual credit card 118 issued by the virtual credit card issuer 170 of the payment processor 132, and links this virtual credit card 118 with the mobile wallet 116 on the mobile device 102 at 216. According to one embodiment, the virtual credit card 118 is representative of a typical credit card account, which is issued and processed by the components of the payment processor 132, e.g., the virtual credit card issuer 170 and the payment processing component 172, thereby allowing the payment processor 132 to suitably issue, top-up, or otherwise administer the card account. Operations of mobile wallet payment processing will be better understood in conjunction with the example implementation set forth in FIG. 3, which illustrates implementation on the mobile device 102 and FIG. 4, which illustrates implementation on the payment processor 132.

Referring now to FIG. 3, there is shown a flowchart 300 that depicts part of an example transaction accomplished in accordance with the systems and methods set forth herein. It will be appreciated that the flowchart 300 is illustrative of the associated user using the mobile device 102, i.e., the mobile wallet 116, for payment to complete a transaction for goods or services provided by the vendor 142. After the user has selected the desired goods or services, uses the mobile device 102 to initiate payment. Accordingly, at 302, the mobile device 102 receives an authorization request 148 including details 150 of the transaction from the vendor 142 via the communications link 140. It will be appreciated that the user may initiate a suitable NFC connection, or one such may be detected by the reader 144, and the authorization request 148 is communicated to the mobile device 102 accordingly. According to one embodiment, the transaction details 150 may include, for example and without limitation, time/date, cost, identification of the goods/services, user/device identification 122, and the like.

At 304, one or more transaction rules 124 are retrieved and analyzed in accordance with the transaction details 122. That is, the mobile wallet 116, via the processor 104, determines whether one or more transaction rules 124 are invoked based upon the transaction details 122, e.g., the predefined payment source 120 requires certain processing rules (identification, user acknowledgement, etc.), PIN numbers required as input from a user, and the like. Any specific rules applicable to the transaction between the mobile device 102 and the vendor 142 are then selectively instituted to facilitate processing of the transaction at 306.

At 308, the mobile wallet 116 in the memory 108 of the mobile device 102 is searched so as to locate any accounts associated with the payment processor 132. A determination is then made at 310 whether the mobile wallet 116 includes a linked virtual credit card 118 from the payment processor 132. Upon a determination that no virtual card 118 is currently available in the mobile wallet 116, operations proceed to 312. At 312, the mobile wallet 116 on the mobile device 102 requests a new virtual credit card 118 to be provided by the payment processor 132. At 314, flow proceeds to FIG. 4, which illustrates the operations of the payment processor 132 in the dynamic generation of a virtual credit card 118 for the purchase initiated by the mobile device 102 in FIG. 3.

Referring now to FIG. 4, operations from FIG. 3 are initiated at 402, and the payment processor 132 receives a request from the mobile wallet 116 operative on the mobile device 102 for a virtual credit card 118. The virtual credit card issuer 170 of the payment processor 132 then identifies the mobile device 102 requesting the card 118, as well as any previously created accounts associated with the device at 406. In one embodiment, the identification of the mobile device 102 is suitably performed in accordance with device identification information 122 that is communicated in association with the request for a virtual credit card 118. The virtual credit card issuer 170 of the payment processor 132 may then identify any accounts previously associated with the mobile wallet 116 of this mobile device 102 stored in the associated database 136.

The virtual credit card issuer 170 of the payment processor 132 then dynamically issues, i.e., generates, at 408, a new virtual credit card 118 for use by the mobile wallet 116 specifically for the current transaction, for the current and subsequent transactions, or the like. In accordance with one embodiment, the virtual credit card issuer 170 of the payment processor 132 is configured to dynamically issue a new credit card that may be used to make purchases, as the virtual credit card issuer 170 of the payment processor 132 is capable of issuing the card and performing the backend validation associated with modern credit card transactions. In such circumstances, the virtual credit card issuer 170 of the payment processor 132 is authorized to issue a credit card on behalf of one or more of the major credit card services, i.e., VISA, MASTERCARD, AMERICAN EXPRESS, DISCOVER. The authorization may be limited to low or high credit line accounts, prepaid accounts, previous establishment of an account with the payment processor 132 (checking, PAYPAL, etc.), or the like. The virtual credit card issuer 170 of the payment processor 132 may issue such a credit card as a virtual credit card 118, i.e., a credit card account issued for the limited purpose of facilitating transactions using the mobile wallet 116 payment mechanism set forth herein. The virtual credit card 118 is then communicated from the payment processor 132 to the mobile wallet 116 of the mobile device 102 at 410. Operations then return to 314 of FIG. 3 at 412.

At 316, the new virtual credit card 118 is received into the mobile wallet 116 of the mobile device 102. That is, the new virtual credit card 118 is linked to the mobile wallet 116 on the mobile device 102 for use in completing mobile payments, as set forth herein. Accordingly, this new credit card may be electronically communicated to the mobile wallet 116 as the virtual credit card 118 referenced above. In such an embodiment, the payment processor 132 may, without prior approval from a lending institution or credit card service, issue such credit cards ‘on-the-fly’, wherein credit cards are issued on an as needed basis and at the time of the sale solely to facilitate completion of that particular sale. In one embodiment, this provisioning of the newly issued virtual credit card 118 may be accomplished in accordance with an over-the-air provisioning service, for example, the MASTERCARD Mobile Over-The-Air Provisioning Service (MOTAPS) allows on-demand activation of NFC mobile phones, for any mobile operator and any NFC enabled handset.

After receipt of the new virtual credit card 118 at 316, or upon the determination at 310 that a virtual card 118 is already present in the mobile wallet 116, operations progress to 318. At 318, an authorization response 152 is sent from the mobile wallet 116 of the mobile device 102 to the vendor 142, which includes the virtual credit card information 118, device/user identification information 122, and the like. Operations then proceed to 414 of FIG. 4.

Turning now to FIG. 4, at 416, a payment request 154 is received from the vendor 142 by the payment processing component 172 of the payment processor 132. The payment request 154 includes, for example, details 150 corresponding to the transaction, the virtual credit card 118, identification information 122 associated with the mobile device 102, i.e., the transaction information 150, the virtual card 118, and the identification information 122 provided by the mobile wallet 116 in the authorization response 152. That is, the vendor 142 sends a request 154 for payment to the payment processing component 172 of the payment processor 132 including the virtual credit card information 118, an identification of the mobile device 102, and the details 150 of the transaction for which payment is requested. In one embodiment, the payment request 154, including the transaction details 150, is communicated to the payment processing component 172 of the payment processor 132 by the mobile device 102, thereby enabling dynamic issuance of the virtual credit card information 118 (if necessary) as set forth in FIG. 2. It will be appreciated that while shown in FIG. 4 as the vendor 142 interacting with the payment processor 132, the mobile wallet 116 operative on the mobile device 102 is also capable of interacting with the payment processor 132 to facilitate communication of the transaction details 150 to the payment processor 132, as set forth herein.

The payment processing component 172 of the payment processor 132 then determines, at 418, whether the mobile device 102 is an authorized device. That is, the payment processing component 172 determines whether the identification information 122 contained in the request 154 from the vendor 142 corresponds to the mobile device 102 associated with the virtual credit card information 118. In one embodiment, the payment processing component 172 of the payment processor 132 may reference stored account information or the like, which corresponds to the mobile device 102 so as to ascertain whether the correct mobile device 102 is associated with the transaction details 150 at 418. Upon a negative determination at 418, i.e., that the mobile device 102 is not authorized, operations proceed to 428, whereupon the transaction is denied by the payment processing component 172. The denial of the transaction is then communicated to the point of sale, e.g., the vendor 142, at 430 and operations with respect to FIG. 4 terminate at 438 and return to 320 of FIG. 3.

Returning to 418, upon a determination that the mobile device 102 associated with the request for payment 154 received by the payment processing component 172 of the payment processor 132 is authorized, operations proceed to 420. At 420, a determination is made whether the mobile wallet 116 indicates that a predefined payment source 120 is to be used to conduct the sale. That is, when the user has indicated a predefined payment source 120 (non-payment processor 132 issued source) for use as the default payment, operations proceed to 422. At 422, the payment processing component 172 of the payment processor 132 identifies the predefined payment source 120 associated with the mobile wallet 116 that is to be used for completion of the transaction. For example, the selected default payment source 120 may correspond to a VISA, MASTERCARD, AMERICAN EXPRESS, or DISCOVER card account, PAYPAL account, etc., that has been registered/linked to the mobile wallet 116 and designated to be used for mobile payments.

A suitable amount of funds are then loaded by the virtual credit card issuer 170 of the payment processor 132 onto the virtual credit card 118 from the predefined payment source 120 at 424. That is, the credit limit or available balance on the virtual credit card 118 is increased or funded by the virtual credit card issuer 170 of the payment processor 132 so as to enable payment to the vendor 142 for the transaction, as indicated in the transaction details 150. It will be appreciated that the amount of funds loaded onto or made available via the virtual credit card 118 may be a user-selected amount, a minimum amount stipulated by the by the virtual credit card issuer 170 of the payment processor 132, only the amount needed to satisfy the transaction, or the like. As discussed above, the “topping up” or loading of funds to the virtual credit card 118 may be transparent to the user, i.e., the user is made aware that the virtual card 118 is being used, or “masked” opaque to the user, i.e., the transaction appears to the user as being executed using the predefined payment source 120. For example, when the user has selected a DISCOVER CARD as the predefined payment form 120, the user's DISCOVER CARD account is charged for the amount used to top up the virtual card 118. Thus, to the user, it appears as if the DISCOVER CARD were used to complete the transaction, and not the virtual card 118 that was dynamically issued for the mobile wallet 116 to use to complete the transaction.

A determination is then made at 426 whether the topping up of the virtual credit card 118 was successfully accomplished. Upon a determination at 426 that the virtual credit card 118 was successfully topped up with funds from the predefined payment source 120, operations proceed to 434, as set forth below. When it is determined at 426 that the funding of virtual credit card 118 was not successful, operations proceed to 428, whereupon the transaction referenced in the received authorization request 148 is denied. For example, when the PAYPAL or registered credit card selected as the default payment source lacks sufficient funds or available credit, the topping up of the virtual credit card 118 will not be able to be completed and thus the transaction will be denied. At 430, the denial of the authorization request 148 is communicated by the payment processing component 172 to the point of sale, e.g., the vendor 142, indicating that the transaction was not completed.

Returning to 420, when it is determined that a predefined payment source 120 was not selected as the default payment source, operations progress to 432. At 432, the available funds or credit available on the virtual credit card 118 are determined by the payment processing component 172 of the payment processor 132. A determination is then made by the payment processing component 172 of the payment processor 132 at 434 whether to authorize the charge in the transaction details 150 of the authorization request 148. When there are insufficient funds or the transaction must be denied for some particular violation of transaction rules 124, or the like, operations proceed to 428, whereupon the transaction is denied. This denial of the transaction is then communicated to the vendor 142 at 430, following which operations with respect to FIG. 4 terminate at 438 and return to 320 of FIG. 3.

When authorization of the charge is affirmed by the payment processing component 172 of the payment processor 132 at 434, operations proceed to 436, whereupon the authorization is communicated to the vendor 142. That is, the payment processing component 172 of the payment processor 132 responds in the affirmative to the authorization request 148. In one embodiment, an affirmative response to the authorization request 148 may be communicated from the payment processor 132 to the mobile device 102 and thereafter to the vendor 142 at 436. Operations of FIG. 4 then terminate at 438 and return to 320 of FIG. 3.

Returning to 320 of FIG. 3, after processing by the payment processing component 172 of the payment processor 132 (as set forth in FIG. 4), a determination is made at 322 whether the transaction has been approved by the payment processor 132. That is, whether the payment processing component 172 of the payment processor 132 has authorized or denied payment to the vendor 142 for the amount set forth in the transaction details 150. Upon a positive determination at 322, operations proceed to 324. At 324, the transaction associated with the authorization request 148 between the mobile device 102 and the vendor 142 is settled, and operations with respect to FIG. 3 terminate thereafter. Upon a determination at 322 that the transaction set forth in the transaction details 150 is denied, operations proceed to 326.

At 326, a determination is made whether the user associated with the mobile device 102 has selected a different credit card or account (e.g., another predefined payment form 120) associated with the mobile wallet 116. Upon a determination at 326 that another payment form 120 is available or input by the user via the mobile device 102, operations return to 318, whereupon the an authorization response 152 is communicated to the vendor 142 including the new card information. Operations then proceed to FIG. 4 at 320 as set forth in greater detail above. Upon a determination at 326 that no selection of another credit card or account is made by the user associated with the mobile device 102, the transaction remains denied and operations with respect to FIG. 3 terminate. It will be appreciated that the implementation set forth in FIGS. 2-4 thus enables any credit card, account, or wallet, to be used as a mobile payment (such as NFC payments) even though such a credit card, account, or wallet issuer may not support NFC and/or mobile capabilities.

The method illustrated in FIGS. 2-4 may be implemented in a computer program product that may be executed on a computer. The computer program product may comprise a non-transitory computer-readable recording medium on which a control program is recorded (stored), such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other tangible medium from which a computer can read and use.

Alternatively, the method may be implemented in transitory media, such as a transmittable carrier wave in which the control program is embodied as a data signal using transmission media, such as acoustic or light waves, such as those generated during radio wave and infrared data communications, and the like.

The exemplary method may be implemented on one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphical card CPU (GPU), or PAL, or the like. In general, any device, capable of implementing a finite state machine that is in turn capable of implementing the flowcharts 200, 300, and 400 shown respectively in FIG. 2, FIG. 3, and FIG. 4, can be used to implement the mobile wallet payment processing method.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

What is claimed is:

1. A method for mobile wallet payment processing, comprising:
receiving a request for a virtual credit card from a mobile wallet operative on an associated mobile device, the request including a device identification and a predefined payment form;
with a processor, dynamically issuing a virtual credit card responsive to the request, the virtual credit card associated with the device identification and the predefined payment form;
communicating the dynamically issued virtual credit card to the mobile wallet operative on the associated mobile device;
receiving a payment request for payment for at least one of a good or a service, the payment corresponding to a charge to the virtual credit card;
verifying funds associated with the virtual credit card relative to the charge of the payment request; and
rendering the payment to the vendor using the virtual credit card responsive to a verification of the funds associated with the virtual credit card.

2. The method of claim 1, wherein the payment request is received from at least one of the vendor or the mobile device.

3. The method of claim 2, wherein verifying funds on the virtual credit card further comprises dynamically loading funds onto the virtual credit card from the predefined payment form in accordance with the charge to the virtual credit card.

4. The method of claim 3, wherein the virtual credit card is a credit card, a charge card, or a prepaid card.

5. The method of claim 4, wherein predefined payment form includes at least one of a checking account, a credit card account, a debit card account, a charge card account, or a savings account.

6. The method of claim 2, wherein the payment request includes the device identification associated with the mobile device, further comprising:
comparing the device identification of the payment request to the device identification associated with the virtual credit card; and
rendering payment when the device identification of the payment request and the device identification associated with the virtual credit card correspond

7. The method of claim 2, wherein dynamically issuing the virtual credit card further comprises receiving at least one transaction detail from the mobile device corresponding to a transaction between the associated mobile device and the at least one vendor, wherein the virtual credit card is issued in accordance with the at least one received transaction detail.

8. The method of claim 7, wherein the at least one transaction detail includes a payment amount, further comprising dynamically loading funds onto the virtual credit card from the predefined payment source corresponding to the payment amount associated with the transaction.

9. The method of claim 8, wherein verifying funds associated with the virtual credit card further comprises comparing funds associated with the virtual credit card to the payment amount associated with the transaction, and
wherein dynamically loading funds onto the virtual credit card from the predefined payment source is in response to a result of the comparing indicating insufficient funds associated with the virtual credit card.

10. The method of claim 8, wherein verifying funds associated with the virtual credit card further comprises:
retrieving at least one transaction rule associated with the transaction and the predefined payment form; and
dynamically loading funds onto the virtual credit card from the predefined payment source is in accordance with the at least one retrieved transaction rule.

11. The method of claim 10, wherein the at least one transaction rule includes at least one of a preselected type of payment, a type of authorization, a type of validation, or a type of user identification.

12. A computer program product comprising a non-transitory recording medium storing instructions, which when executed on a computer causes the computer to perform the method of claim 1.

13. A system comprising memory storing instructions for performing the method of claim 1, and a processor in communication with the memory which implements the instructions.

14. A mobile wallet payment processing system, comprising:
a virtual credit card issuer configured for dynamically issuing a virtual credit card in response to a request received from a mobile wallet on an associated mobile device, the request including a device identification and a predefined payment form, and communicating the dynamically issued virtual credit card to the mobile wallet;
a payment processing component configured for:
analyzing a payment request for payment of a transaction for at least one of a good or a service, the payment corresponding to a charge to the virtual credit card,
verifying funds associated with the virtual credit card relative to the charge of the payment request, and
rendering the payment to the vendor using the virtual credit card responsive to a verification of the funds associated with the virtual credit card; and
a processor which implements at least one of the virtual credit card issuer and the payment processing component.

15. The system of claim 14, wherein the payment request is received from at least one of the vendor or the mobile device.

16. The system of claim 15, wherein the payment request includes the device identification associated with the mobile device, and wherein the payment processing component is further configured for:
comparing the device identification of the payment request to the device identification associated with the virtual credit card; and
rendering payment when the device identification of the payment request and the device identification associated with the virtual credit card correspond.

17. The system of claim 15, wherein the virtual credit card issuer is further configured for:
receiving at least one transaction detail from the mobile device corresponding to the transaction between the associated mobile device and the vendor, the at least one transaction detail including a payment amount;
comparing funds associated with the virtual credit card to the payment amount associated with the transaction; and
dynamically loading funds onto the virtual credit card from the predefined payment source corresponding to the payment amount associated with the transaction in response to a result of the comparing indicating insufficient funds associated with the virtual credit card.

18. The system of claim 17, wherein the virtual credit card issuer is further configured for:
retrieving at least one transaction rule associated with the transaction and the predefined payment form from an associated database; and
dynamically loading funds onto the virtual credit card from the predefined payment source in accordance with the at least one retrieved transaction rule.

19. A computer-implemented method for mobile wallet payment processing, comprising:
selecting at least one predefined payment form corresponding to at least one of a checking account, a savings account, a credit card account, a debit card account, or a charge account;
linking, with a processor, the at least one selected predefined payment source to a mobile wallet on an associated mobile device;
receiving a dynamically issued virtual credit card from an associated payment processor, the virtual credit card funded from the at least one selected predefined payment source linked to the mobile wallet;
receiving an authorization request from a vendor for payment for at least one of a good or a service, the payment corresponding to a charge to the virtual credit card; and
rendering the payment to the vendor using the virtual credit card responsive to an approval of the authorization request.

20. The computer-implemented method of claim 19, wherein rendering the payment further comprises:
communicating the virtual credit card, a device identification, and an authorization to at least one of the vendor and the payment processor;
receiving an approval from the payment processor responsive to a payment request from the vendor; and
rendering the payment to the vendor in response to the approval from the payment processor.
